(19) United States
(12) Patent Application Publication
(10) Pub. No.: US 2014/0174198 A1
(43) Pub. Date: Jun. 26, 2014

(54) MICROFLUIDIC DISK FOR MEASURING MICROFLUID AND METHOD FOR MEASURING MICROFLUID

(71) Applicant: POSTECH ACADEMY-INDUSTRY FOUNDATION, Pohang-si (KR)

(72) Inventors: Dong Sung KIM, Pohang-si (KR); Moonwoo La, Chuncheon-si (KR)

(73) Assignee: Postech Academy-Industry Foundation, Pohang-si (KR)

(21) Appl. No.: 13/795,150

(22) Filed: Mar. 12, 2013

(30) Foreign Application Priority Data
Dec. 21, 2012 (KR) 10-2012-0151208

(51) Int. Cl. G01F 3/02

(52) U.S. Cl. CPC G01F 3/02
USPC 73/861.39

(57) ABSTRACT

A microfluidic disk includes: a disk-shaped main body; an injection port; a distribution channel; measuring vessels; microvalves; a wastewater container; and holding containers.

### CROSS-REFERENCE TO RELATED APPLICATION

This application claims priority to and the benefit of Korean Patent Application No. 10-2012-0151208 filed in the Korean Intellectual Property Office on Dec.21, 2012, the entire contents of which are incorporated herein by reference.

### BACKGROUND OF THE INVENTION

(a) Field of the Invention

The present invention relates to a microfluidic disk for measuring microfluid and a method for measuring microfluid.

(b) Description of the Related Art

In general, to conduct a microfluidic flow test on the separation, mixing, and reaction of microfluid, an adequate amount of fluid should be measured first.

Conventionally, microfluid is measured using a precise measuring device, such as a pipet or cartridge, and then a microfluidic flow test is conducted using a disk-based microfluidic system. However, the precision of measurement of several microliters (1 to 10 μl) of fluids is not high, and the injection process of measured microfluid into the disk-based microfluidic system may face difficulties or cause volume loss.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention has been made in an effort to provide a microfluidic disk and a method for measuring microfluid by which microfluid can be precisely and efficiently measured, and a microfluidic flow test using a disk-based microfluidic system can be efficiently conducted.

A first exemplary embodiment of the present invention provides a microfluidic disk including: a disk-shaped main body that rotates by itself on its central axis along a rotational direction; an injection port that is formed on the disk-shaped main body and receives fluid from outside; a distribution channel that extends from the injection port along the rotational direction while maintaining a predetermined distance from the central axis, and allows the fluid to pass therethrough; measuring vessels that extend from the distribution channel toward the edge of the disk-shaped main body, and hold a predetermined volume of the fluid; microvalves that are connected to ends of the measuring vessels and controlled to be opened and closed by rotational angular velocity of the disk-shaped main body; a wastewater container that is connected to ends of the distribution channel and holds the fluid; and holding containers that are connected to the microvalves and positioned between the distribution channel and the edge of the disk-shaped main body, and hold the fluid that has passed through the microvalves.

Ends of the microvalves connected to the holding containers may be fan-shaped.

The microvalves may be closed when the disk-shaped main body rotates at a first rotational angular velocity, and opened when the disk-shaped main body rotates at a second rotational angular velocity which is faster than the first rotational angular velocity.

The microfluidic disk may further include air outlets connected to the wastewater container and the holding containers.

The measuring vessels may be provided in plural form, and the plurality of measuring vessels may be spaced apart from each other at predetermined intervals and extend from the distribution channel.

A second exemplary embodiment of the present invention provides a method for measuring microfluid, the method including: preparing the microfluidic disk; injecting fluid into the injection port; rotating the disk-shaped main body at a first rotational angular velocity so that the fluid passes through the distribution channel and is positioned only in the measuring vessels, and measuring the fluid; and rotating the disk-shaped main body at a second rotational angular velocity which is faster than the first rotational angular velocity to open the microvalves and hold a measured volume of the fluid in the holding containers.

According to one of several exemplary embodiments of the solution according to the invention, there are provided a microfluidic disk and a method for measuring microfluid, by which microfluid can be precisely and efficiently measured, and a microfluidic flow test using a disk-based microfluidic system can be efficiently conducted.

### BRIEF DESCRIPTION OF THE DRAWINGS

FIG. 1 is a view showing a microfluidic disk according to a fist exemplary embodiment of the present invention.

FIG. 2 is a view for explaining a method for measuring microfluid according to a second exemplary embodiment of the present invention.

FIG. 3 is a photograph illustrating an experimental example of the method for measuring microfluid according to the second exemplary embodiment of the present invention that uses the microfluidic disk according to the first exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Further, the sizes and thicknesses of the elements shown in the drawings are arbitrarily shown for convenience of description, and thus embodiments are not limited to those illustrated.

In addition, unless explicitly described to the contrary, the word “comprise” and variations such as “comprises” or “comprising” will be understood to imply the inclusion of stated elements but not the exclusion of any other elements.

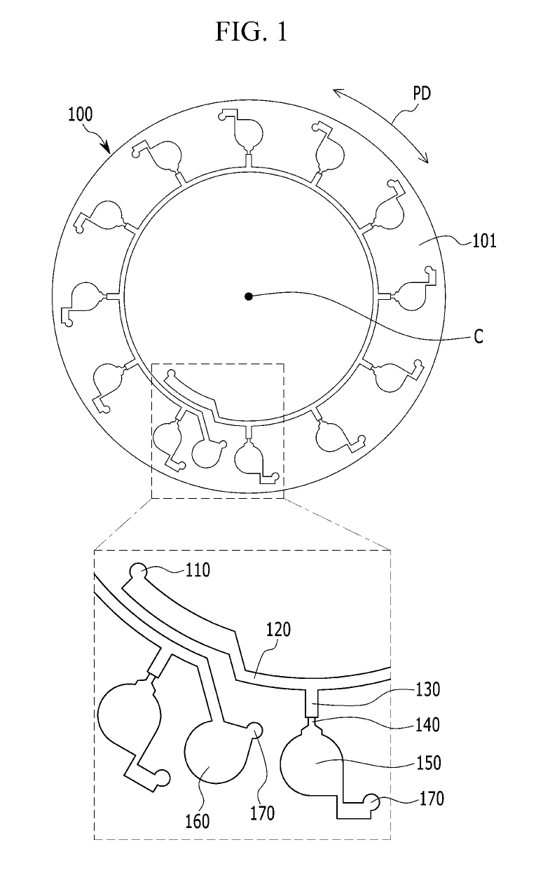

Hereinafter, a microfluidic disk according to a first exemplary embodiment of the present invention will be described with reference to FIG. 1.

FIG. 1 is a view showing a microfluidic disk according to a fist exemplary embodiment of the present invention.

As shown in FIG. 1, the microfluidic disk 100 according to the first exemplary embodiment of the present invention may be connected to a drive part for rotating the microfluidic disk 100, a sensor for detecting a rotational angular velocity of the microfluidic disk 100, and a control part connected to the sensor and the drive part to control the rotational angular velocity of the microfluidic disk 100. The microfluidic disk 100 may include a disk-shaped main body 101, an injection port 110, a distribution channel 120, measuring vessels 130, microvalves 140, holding containers 150, a wastewater container 160, and air outlets 170.

The disk-shaped main body 101 has a circular disk shape, and rotates by itself on the central axis C along a rotational direction RD. The disk-shaped main body 101 can rotate by itself by using the drive part connected to the disk-shaped main body 101, and its rotational angular velocity can be controlled by the control part. In the disk-shaped main body 101, the injection port 110, the distribution channel 120, the measuring vessels 130, the microvalves 140, the holding containers 150, the wastewater container 160, and the air outlets 170 may be formed through MEMS technology, including photolithography and precision micromachining, or through injection molding using a mold insert having an inverse pattern, such as embossing, or may be imprinted through mass production methods, including hot embossing, UV-molding, and casting. The disk-shaped main body 101 may be formed from a metallic material, a ceramic material, or a polymer material such as COC (cyclic olefin copolymer), PMMA (polymethylmethacrylate), PS (polystyrene), PC (polycarbonate), PDMS (polydimethylsiloxane), Teflon (polytetrafluoroethylene), or PVC (polyvinylchloride).

The injection port 110 is formed on the disk-shaped main body 101 in proximity to the central axis C, and is a passage through which fluid is injected from the outside. Fluid is injected into the injection port 110 at a constant pressure by using a pipet, a cartridge, a pneumatic pump, etc.

The distribution channel 120 extends from the injection port 110 along the rotational direction RD while maintaining a predetermined distance from the central axis C, and allows fluid to pass therethough. Specifically, the distribution channel 120 is connected to the injection port 110, and is disposed in a circumferential direction within the disk-shaped main body 101 while maintaining a given distance from the central axis C. The distribution channel 120 is a passage through which fluid supplied from the injection port 110 is held and delivered.

The measuring vessels 130 extend from the distribution channel 120 toward the edge of the disk-shaped main body 101, and hold a predetermined volume of the fluid passing through the distribution channel 120. Specifically, the measuring vessels 130 are vertically connected to the distribution channel 120, and disposed in a radial direction from the central axis C. The fluid delivered through the distribution channel 120 is held in the measuring vessels 130, and is measured by the volume that the measuring vessels can hold. The measuring vessels 130 are provided in plural form, and the plurality of measuring vessels 130 are spaced apart from each other at predetermined intervals and extend from the distribution channel 120 toward the edge of the disk-shaped main body 101.

The microvalves 140 are connected to ends of the measuring vessels 130 to interconnect the measuring vessels 130 and the holding containers 150, and are controlled to be opened and closed by the rotational angular velocity of the disk-shaped main body 101. The microvalves 140 are disposed between the measuring vessels 130 and the holding containers 140. While the flow of fluid is restricted during fluid measurement using the measuring vessels 130, the flow of fluid is permitted during delivery of a measured volume of fluid. The opening and closing of the microvalves 140, which interconnect the measuring vessels 130 and the holding containers 150, are controlled by the rotational angular velocity 101 of the disk-shaped main body 101; more specifically, the opening and closing of the microvalves 140 are controlled by the difference between a first pressure formed around the microvalves 140 by centrifugal force generated by rotation of the disk-shaped main body 101 and a second pressure formed by surface tension within the microvalves 140. For example, if the first pressure is greater than the second pressure, the microvalves 140 are opened and fluid flows from the measuring vessels 130 to the holding containers 150 via the opened microvalves 140. Otherwise, if the second pressure is greater than the first pressure, the microvalves 140 are closed and fluid does not flow from the measuring vessels 130 to the holding containers 150 via the opened microvalves 140. Since the first pressure is proportional to the rotational angular velocity of the disk-shaped main body 101, the rotational angular velocity of the disk-shaped main body 101 is controlled such that the second pressure is greater than the first pressure during fluid measurement and the first pressure is greater than the second pressure after fluid measurement. As such, the opening and closing of the microvalves 140 can be controlled according to before and after fluid measurement by controlling the rotational angular velocity of the disk-shaped main body 101. For example, the microvalves 140 are closed when the disk-shaped main body 101 rotates at a first rotational angular velocity, and opened when the disk-shaped main body 101 rotates at a second rotational angular velocity, which is faster than the first rotational angular velocity. That is, the opening and closing of the microvalves 140 are controlled according to the rotational angular velocity of the disk-shaped main body 101. Ends of the microvalves 140 connected to the holding containers 150 are fan-shaped, which prevents interruption of the flow of fluid passing through the microvalves 140.

The holding containers 150 are connected to the microvalves 140 and positioned between the distribution channel 120 and the edge of the disk-shaped main body 101, and hold the fluid that has passed through the microvalves 140.

The wastewater container 160 is connected to an end of the distribution channel 120, and holds the fluid that has passed through the distribution channel 120. Specifically, the wastewater container 160 is connected to an end of the distribution channel 120 that is farthest from the injection port 110, and holds the fluid to be delivered and discharged through the distribution channel 120 during fluid measurement.

The air outlets 170, which are connected to the wastewater container 160 and the holding containers 150, are passages through which air filling the inside of each container exits when fluid is supplied to each container. The air outlets 170 allow air in the channel or the containers to smoothly exit during fluid flow so that fluid smoothly flows in the above-mentioned channel and containers.

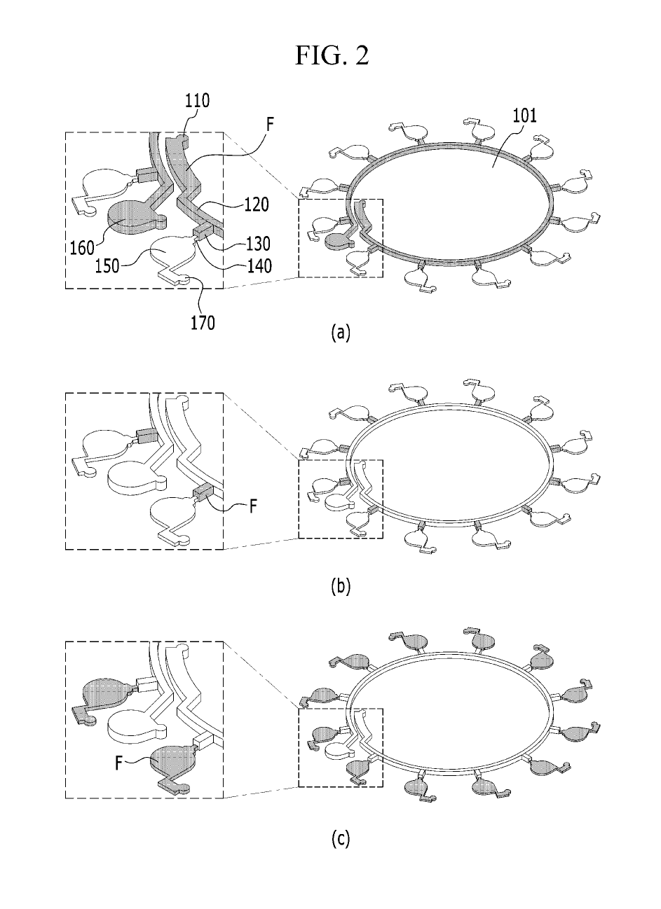

Now, a method for measuring microfluid according to a second exemplary embodiment of the present invention which uses the microfluidic disk 100 according to the first exemplary embodiment of the present invention will be described with reference to FIG. 2.

FIG. 2 is a view for explaining a method for measuring microfluid according to a second exemplary embodiment of the present invention.

First, the above-described microfluidic disk 100 according to the first exemplary embodiment of the present invention is provided.

Next, as shown in (a) of FIG. 2, fluid F is injected into the injection port 110.

Specifically, the fluid F is supplied to the distribution channel 120 through the injection port 110, and is then supplied to the measuring vessels 130. In this process, the fluid F supplied to the inside of the measuring vessels 130 is restricted from flowing to the holding containers 150 by means of the microvalves 140 connected to the measuring vessels 130.

Next, as shown in (b) of FIG. 2, the disk-shaped main body 101 is rotated at a first rotational angular velocity so that the fluid F is positioned only in the measuring vessels 130, and the fluid F is measured.

Specifically, the fluid F injected into the distribution channel 120 by a centrifugal force generated as the disk-shaped main body 101 rotates along a rotational direction is delivered through the distribution channel 120 and held in the wastewater container 160. In this process, the centrifugal force creates a “doctor-blade” effect at interfaces between the distribution channel 120 and the measuring vessels 130, influenced by the structure of the measuring vessels 130 vertically connected to the distribution channel 120. Thus, the connection between the fluid F supplied to the inside of the distribution channel 120 and the fluid F supplied to the inside of the measuring vessels 130 is interrupted, and the fluid F is automatically measured by the volume that the measuring vessels 130 can hold. In this process, the fluid F supplied to the measuring vessels 130 is still restricted from flowing to the holding containers 150 by means of the microvalves 140. As a result, the fluid F supplied to the distribution channel 120 is discharged to the wastewater container 160, and the fluid F remains only in the measuring vessels 130.

Next, as show in (c) of FIG. 2, the disk-shaped main body 101 is rotated at a second rotational angular velocity, which is faster than the first rotational angular velocity, to open the microvalves 140 and hold a measured volume of the fluid F in the holding containers 150.

Specifically, the disk-shaped main body 101 is rotated at the second rotational angular velocity, which is faster than the first rotational angular speed for microfluid measurement, so that the fluid F measured in the measuring vessels 130 passes through the microvalves 140 and is delivered to the holding containers 150. As a result, the fluid F measured in the measuring vessels 130 is delivered and held in the holding containers 150. In this process, ends of the microvalves 140 connected to the holding containers 150 are fan-shaped, which prevents interruption of the flow of the fluid F passing through the microvalves 140 and facilitates its delivery to the holding containers 150. The fluid F held in the holding containers 150 flows to another disk-based microfluidic system connected to the holding containers 150, or to another channel or container connected to the holding containers 150 to undergo a microfluid flow test. Meanwhile, if the microvalves 140 are bar-shaped, the flow of the fluid F passing through the microvalves 140 may be interrupted by the centrifugal force of the fluid F, and some of the fluid F may remain in the measuring vessels 130.

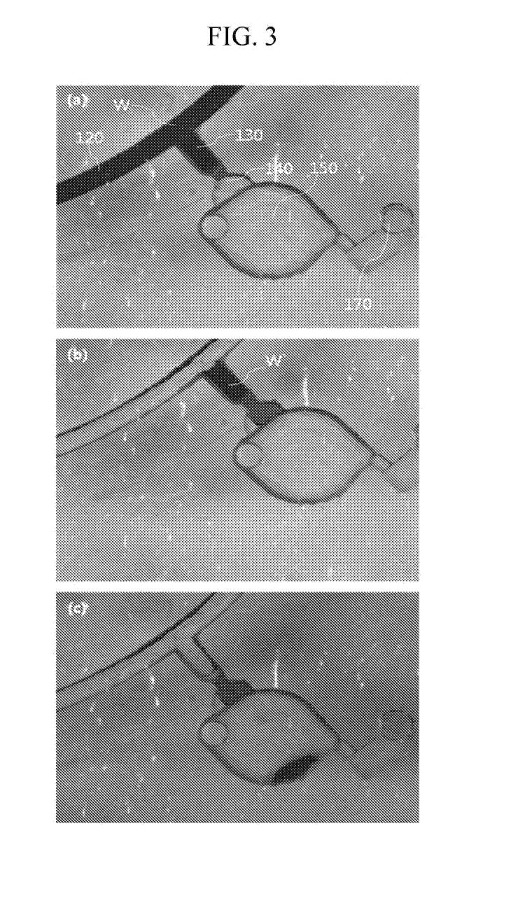

Now, an experimental example of the method for measuring microfluid according to the second exemplary embodiment of the present invention that uses the microfluidic disk 100 according to the first exemplary embodiment of the present invention will be described with reference to FIG. 3.

FIG. 3 is a photograph illustrating an experimental example of the method for measuring microfluid according to the second exemplary embodiment of the present invention that uses the microfluidic disk 100 according to the first exemplary embodiment of the present invention. In FIG. 3, the fluid is microvolume deionized water.

As shown in (a) of FIG. 3, deionized water W injected through the injection port 110 is supplied to the distribution channel 120 and the measuring vessels 130. In this process, it was observed that the deionized water W supplied to the measuring vessels 130 was restricted from flowing.

As shown in (b) of FIG. 3, the deionized water W supplied to the distribution channel 120 by centrifugal force generated by rotation of the disk-shaped main body 101 is discharged and held in the wastewater container 160. At the same time, the deionized water W′ supplied to the measuring vessels 130 is separated from the deionized water W supplied to the distribution channel 120, and is measured by the volume that the measuring vessels 130 holds and remains in the measuring vessels 130. In this process, it was observed that the deionized water W′ measured by the measuring vessels 130 was restricted from flowing by means of the microvalves 140.

As shown in (c) of FIG. 3, it was observed that the deionized water W′ measured by the measuring vessels 130 passed through the microvalves 140 and was delivered and held in the holding containers 150 by rotating the disk-shaped main body 101 at a rotational angular velocity faster than the rotational angular velocity for microfluid measurement.

As seen from the above, by the microfluidic disk 100 according to the first exemplary embodiment of the present invention and the method for measuring microfluid using the microfluidic disk 100 according to the second exemplary embodiment of the present invention, fluid F injected through the injection port 110 can be measured to have a target volume by using the measuring vessels 130, and then a microfluid flow test is conducted on the measured microfluid F by connecting the holding containers 150 and a disk-shaped microfluidic system for microfluid flow testing. Therefore, fluid can be precisely and efficiently measured, and a microfluidic flow test using a disk-based microfluidic system can be efficiently conducted. Accordingly, no additional devices and modules are required to deliver a measured volume of fluid to a structure (disk-shaped microfluidic system) for microfluid flow testing. This may reduce the overall cost and time for microfluid flow testing.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

Disk-shaped main body 101, injection port 110, distribution channel 120, measuring vessel 130, microvalve 140, holding container 150, wastewater container 160

What is claimed is:

1. A microfluidic disk comprising:
a disk-shaped main body that rotates by itself on its central axis along a rotational direction;
an injection port that is formed on the disk-shaped main body and receives fluid from outside;
a distribution channel that extends from the injection port along the rotational direction while maintaining a predetermined distance from the central axis, and allows the fluid to pass therethrough;
measuring vessels that extend from the distribution channel toward the edge of the disk-shaped main body, and hold a predetermined volume of the fluid;
microvalves that are connected to ends of the measuring vessels and controlled to be opened and closed by rotational angular velocity of the disk-shaped main body;
a wastewater container that is connected to ends of the distribution channel and holds the fluid; and
holding containers that are connected to the microvalves and positioned between the distribution channel and the edge of the disk-shaped main body, and hold the fluid that has passed through the microvalves.

2. The microfluidic disk of claim 1, wherein ends of the microvalves connected to the holding containers are fan-shaped.

3. The microfluidic disk of claim 1, wherein the microvalves are closed when the disk-shaped main body rotates at a first rotational angular velocity, and opened when the disk-shaped main body rotates at a second rotational angular velocity which is faster than the first rotational angular velocity.

4. The microfluidic disk of claim 1, wherein the microfluidic disk further comprises air outlets connected to the wastewater container and the holding containers.

5. The microfluidic disk of claim 1, wherein the measuring vessels are provided in plural form, and the plurality of measuring vessels are spaced apart from each other at predetermined intervals and extend from the distribution channel.

6. A method for measuring microfluid, the method comprising:
preparing the microfluidic disk of claim 1;
injecting fluid into the injection port;
rotating the disk-shaped main body at a first rotational angular velocity so that the fluid passes through the distribution channel and is positioned only in the measuring vessels, and measuring the fluid; and
rotating the disk-shaped main body at a second rotational angular velocity, which is faster than the first rotational angular velocity, to open the microvalves and hold a measured volume of the fluid in the holding containers.
